(19) United States
(12) Patent Application Publication
(10) Pub. No.: US 2014/0278616 A1
(43) Pub. Date: Sep. 18, 2014

(54) MULTI-MODAL FARE CALCULATION METHOD, SYSTEM AND APPARATUS

(71) Applicant: Apple Inc., Cupertino, CA (US)

(72) Inventors: Doug STONE, New York, NY (US); Alexander TESOV, New York, NY (US)

(73) Assignee: Apple Inc., Cupertino, CA (US)

(21) Appl. No.: 13/843,662

(22) Filed: Mar. 15, 2013

(51) Int. Cl. G06Q 10/02; G06Q 30/02

(52) U.S. Cl. CPC G06Q 10/025; G06Q 30/0283
USPC 705/6

(57) ABSTRACT

A computer-implemented method and system are provided for dynamically evaluating fares over multiple itineraries for a journey involving multiple modes of transit and served by one or more mass transit providers. A non-transitory computer-readable medium is also provided that includes a plurality of instructions that, when executed by at least one electronic device, at least cause the at least one network-connectable device to evaluate fares over multiple itineraries for a journey involving multiple modes of transit and served by one or more mass transit providers. An apparatus for evaluating fares over multiple itineraries for a journey, along with a method of operation of an apparatus, is also provided.

### TECHNICAL FIELD

This invention relates to an interactive method, system and apparatus for calculating a total fare charged for conveyance of passengers across journeys serviced by one or more mass transit service providers.

### BACKGROUND

Methods and systems have been developed for providing transit directions that may be useful for driving, walking and/or navigating one or more routes between a start point and a destination point. Such methods and systems may accesses the online databases of various mass transport providers that provide multiple transit modes including, but not limited to, trains, subways, buses, ferries, helicopters, planes, bicycles and other forms of urban transit.

Data on mass transit providers, which has been frequently unavailable online and typically inaccessible electronically by third parties, can now incorporate the “local” knowledge of commuters who walk down the local streets and use mass transit routes on a daily basis (see Applicant's co-owned U.S. Pat. No. 7,957,871, the entire disclosure of which is incorporated by reference herein). Incorporating the feedback and ratings of these users into the algorithms and calculations of mass transit routes and stops is a novel approach that improves the value of information provided to the user. Such information is particularly helpful in the navigation of journey segments, which are portions of a projected journey that may be traveled via multiple transport modes. Such transport modes may be serviced by different agencies that, while cooperating with one another, do not readily share fare information so that passengers can readily access a total fare calculated for the entirety of a journey.

Additional attributes are provided herein that are intuitively used by passengers for optimizing fare calculation for journeys having one or more segments serviced by one or more mass transit providers and local mass transit providers.

### SUMMARY

In accordance with the principles of the presently disclosed inventions, methods, systems and computer readable media can be implemented for dynamically evaluating fares over multiple itineraries. Such itineraries are generated by at least one module for a journey involving multiple modes of transit and served by one or more local mass transit providers. For example, a method is provided that includes inputting a starting address and a destination address of a journey during which a passenger accesses at least one local mass transit provider from a plurality of mass transit providers during one or more journey segments. A start point and an end point for each journey segment are identified, and mass transit directions are determined that afford access to at least one mass transit provider during each journey segment. Each segment is identified as being served by a different mass transit provider. Cumulative fares are calculated for the mass transit providers providing transit services during the journey. For each itinerary, the cumulative fares are displayed with at least one of textual descriptions and graphical descriptions of the mass transit directions.

The method may further include providing a platform having a network interface that enables performance of actions including at least one of communicating over a network; inputting the starting and destination addresses for a requested journey; inputting journey customization data; facilitating registration of at least one passenger requesting the mass transit directions; and accessing the platform by the registered passenger. The platform further includes a database that stores cumulative fare data. The cumulative fare data includes pre-specified fare data for each segment served by a mass transit provider and acquired from at least one data feed. The cumulative fare data also includes rule-dependent fare data for calculating fares dependent upon the fare rules being applied to one or more segments of the requested journey. An engine is also provided that is configured to perform at least one of validating the starting and destination addresses for the requested journey; determining the mass transit directions between two nodes in a network comprising a plurality of nodes; associating the third-party fare data with a given segment; and calculating and setting a cumulative fare for each itinerary generated for the requested journey.

The network interface may include a journey input page for inputting at least one of the start point of the journey, the end point of the journey, one or more preferred transportation modes, one or more preferred local mass transit providers and preferred walking distances between a location of an end point of one journey segment and a location of a start point of another journey segment.

The platform may further include a network interface for allowing a passenger to provide feedback on at least one of accuracy of the cumulative fare data and quality of the mass transit directions. Such a network interface may provide access to a collaborative social network.

The journey customization data may include at least one transit region selected from a plurality of transit regions in which the cumulative fare data is calculated, directions for each segment of a journey, one or more maps, one or more transit schedules and one or more guides for a selected transit region.

The validating may include identifying a location where the passenger has indicated a first segment of the journey will commence, identifying a location where the passenger has indicated a final segment of the journey will end and searching for a chain of segments in which each of the journey's start and end locations. Each segment's start and end locations may also be sought and located in identified groups of coordinates identifiable as being served by a mass transit provider.

The network interface may perform at least one of facilitating purchase of a fare for at least one of the requested journey and any given segment thereof; and presenting confirmation of fare payment on a network-connected device.

A multi-modal fare calculation system is also be provided for evaluating fares over multiple itineraries for a journey involving multiple modes of transit and served by one or more local mass transit providers. The system includes a journey input module that receives a starting address and a destination address of a journey during which a passenger accesses at least one mass transit provider from a plurality of mass transit providers during two or more journey segments. An identifying module is provided for identifying a start point and an end point for each journey segment. A determining module is also provided for determining mass transit directions that afford access to at least one mass transit provider during each journey segment with each segment being served by a different mass transit provider. A calculating module in the system calculates cumulative fares for the mass transit providers providing transit services during the journey. A display module of the system displays, for each itinerary, the cumulative fares with at least one of textual descriptions and graphical descriptions of the mass transit directions. The system also includes a server in communication with a network and, optionally, at least one network-connectable device.

An apparatus is also provided for evaluating fares over multiple itineraries for a journey involving multiple modes of transit and served by multiple mass transit providers. The apparatus includes a network interface for communicating over a network and a computer-readable medium. The computer-readable medium may be configured to perform actions that include inputting a starting address and a destination address of a journey during which a passenger accesses at least one mass transit provider from a plurality of mass transit providers during two or more journey segments; identifying a start point and an end point for each journey segment; determining mass transit directions that afford access to at least one mass transit provider during each journey segment with each segment being served by a different mass transit provider; calculating cumulative fares for the mass transit providers providing transit services during the journey; and for each itinerary, displaying the cumulative fares with at least one of textual descriptions and graphical descriptions of the mass transit directions. The computer readable medium can include one medium or plural media such as separate structures. Any software that carries out the steps and functions described herein can be stored on a non-transitory medium. Computer-readable instructions that may be recorded on a non-transitory medium can, when executed, perform one or more steps of the functions described herein without any deference to sequence.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an example of a computing environment in which embodiments of the presently disclosed system and process may be implemented.

FIG. 2 shows an exemplary process for calculating a cumulative fare for a journey via a network interface.

FIG. 2A shows an exemplary cumulative fare calculation process that is executed during the exemplary process shown and described with respect to FIG. 2.

FIG. 3 shows an exemplary journey input page presented by a network interface.

FIG. 4 shows an exemplary network interface for a fare calculation application provided via a network-connected device.

### DETAILED DESCRIPTION

Now referring to the figures, wherein like numbers represent like elements, a multi-modal fare calculation method and system as described herein may be implemented in connection with a mobile networking apparatus that includes hardware, software, or, where appropriate, a combination of both. It is contemplated that functional implementation of any invention described herein may be implemented equivalently in firmware and/or other available functional components or building blocks, and that networks may be wired, wireless or a combination of wired and wireless.

FIG. 1 sets forth illustrative electrical data processing functionality 100 that can be used to implement aspect of the functions described herein. In one case, the processing functionality 100 may correspond to a computing device that includes one or more processing devices. The computing device can include a computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment illustrated in FIG. 1 is not intended to limit the present disclosure, and that other alternative hardware and/or software environments may be used without departing from the scope of this disclosure.

For clarity, as used herein, the term “server” includes one or more servers. A server can include one or more computers that manage access to a centralized resource or service in a network. A server can also include at least one program that manages resources (for example, on a multiprocessing operating system where a single computer can execute several programs at once). Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The processing functionality 100 can include volatile memory (such as RAM 102) and/or non-volatile memory (such as ROM 104 as well as any supplemental levels of memory, including but not limited to cache memories, programmable or flash memories and read-only memories, including dynamic read-only memories). The processing functionality can also include one or more processing devices 106 (e.g, one or more central processing units (CPUs), one or more graphics processing units (GPUs), one or more microprocessors (μP) and similar and complementary devices) and optional media devices 108 (e.g., a hard disk module, an optical disk module, etc.).

The processing functionality 100 can perform various operations identified above with the processing device(s) 106 executing instructions that are maintained by memory (e.g., RAM 102, ROM 104 or elsewhere). The disclosed method and system may also be practiced via communications embodied in the form of program code that is transmitted over some non-transient medium, such as over electrical wiring or cabling, through fiber optics, wirelessly or via any other form of transmission, wherein, when the program code is received and loaded into and executed by a machine, such as an EPROM, a gate array, a programmable logic device (PLD), a client computer, or the like, the machine becomes an apparatus for practicing the presently disclosed system and method. When implemented on a general-purpose processor, the program code combines with the processor to provide a unique apparatus that operates to invoke the functionality of the presently disclosed system and method. Additionally, any storage techniques used in connection with the presently disclosed method and/or system may invariably be a combination of hardware and software.

The processing functionality 100 also includes an input/output module 110 for receiving various inputs from a user (via input modules 112) and for providing various outputs to the user. One particular output mechanism may include a presentation module 114 and an associated graphical user interface (GUI) 116 incorporating one or more I/O devices (including but not limited to a display, a keyboard/keypad, a mouse and/or other pointing device, a trackball, a joystick, a haptic feedback device, a motion feedback device, a voice recognition device, a microphone, a speaker, a touch screen, a touchpad, a webcam, 2-D and 3-D cameras, and similar and complementary devices that enable operative response to user commands that are received at a computing device).

Otherwise, user input may be received via a computing device coupled to another computing device over a network. The processing functionality 100 can also include one or more network interfaces 118 for exchanging data with other devices via one or more communication conduits 120. One or more communication buses 122 communicatively couple the above-described components together. Bus 122 may represent one or more bus structures and types, including but not limited to a memory bus or memory controller, a peripheral bus, a serial bus, an accelerated graphics port, a processor or local bus using any of a variety of bus architectures and similar and complementary devices. This configuration may be desirable where a computing device is implemented as a server or other form of multi-user computer, although such computing device may also be implemented as a standalone workstation, desktop, or other single-user computer in some embodiments. In such configuration, the computing device desirably includes a network interface in operative communication with at least one network. The network may be a LAN, a WAN, a SAN, a wireless network, a cellular network, radio links, optical links and/or the Internet, although the network is not limited to these network selections. It will be apparent to those skilled in the art that storage devices utilized to provide computer-readable and computer-executable instructions and data can be distributed over a network.

The computing device can operate under the control of an operating system that executes or otherwise relies upon various computer software applications. For example, a database management system (DBMS) may be resident in the memory to access one or more databases (not shown). The databases may be stored in a separate structure, such as a database server, connected, either directly or through a communication link, with the remainder of the computing device. Moreover, various applications may also execute on one or more processors in another computer coupled to the computing device via a network in a distributed or client-server computing environment.

Transmission and reception of data or information can be between computers, databases, storage devices, or internal computer equipment is carried by transmitting electrical signals (e.g., carrying packets or messages) using computer equipment and are also carried by generating signals in response (e.g., consistent with the steps or processes described herein). A computer or computer system can be one or more computers. A network can also involve multiple networks.

With reference now to FIG. 2, a user can initiate a multi-modal fare calculation method by initiating process 200 for obtaining directions along one or more segments of a route in which the one or more segments are served at least in part by a mass transit provider. A computer system (e.g., one or more computers) such as computer systems, network, or equipment described herein is configured to perform the illustrative method steps illustratively described herein by way of encoded computer executable software instructions.

As used herein, a “user” may be a single user or a group of users and may include individual riders or groups of riders (e.g., senior citizens, mobility-impaired passengers, employees of a particular business and any other individual, group or organization that might utilize one or more mass transit providers). As used herein, the term “user” (or “user device”, “client device”, “network-connected device” or “device”) can refer to any electronic apparatus configured for receiving control input and configured to send commands or data either interactively or automatically to other devices. A user device can be an instance of an online user interface hosted on servers as retrieved by a user. As used herein, the term “process” or “method” refers to one or more steps performed at least by one electronic or computer-based apparatus. Those of ordinary skill understand from the present description that the illustrative processes or steps described herein can be implemented in different sequences or orders if desired. Also, steps can be removed, modified, or added without varying from the scope and principles of the present invention.

As used herein, a “mass transit provider”, “transit provider”, “mass transit service provider” or “service provider” can refer to an agency or entity that provides services for the conveyance of passengers along at least a portion of a route segment. For multi-segment journeys, it is presumed that different segments are served at least in part by different mass transit providers (for example, a first segment may be served by one mass transit provider, and a second segment may be at least partially served by another mass transit provider with the remainder of the segment being served by one of yet another mass transit provider or not served by any mass transit provider). For segments or partial segments not served by any mass transit provider, a passenger may walk or utilize other conveyances that are not managed by a mass transit provider. A mass transit provider may provide a conveyance that transports passengers that do not own the conveyance, whether for free or for payment. Exemplary conveyances that may be provided by mass transit providers are provided in co-owned U.S. Pat. No. 7,957,871 (the “'871 Patent”), the entire disclosure of which is incorporated by reference herein.

A process 200 starts at Step 202 when a user accesses a multi-modal fare calculation system. At Step 204, access may be granted via a network interface such as a journey input page 300 as shown and described with respect to FIG. 3. Journey input page 300 may incorporate a log-in feature 302 that may present a login page (not shown) for the multi-modal fare calculation system. In some embodiments utilizing a log-in page, a log-in may not be immediately presented but may be accessible from another web page or from a mobile application. In such embodiments utilizing a log-in page, the user may submit login credentials via the login page, although in alternative embodiments, this step may performed by software, such as a script that enters the login credentials when the login page is presented.

At Step 204, a decision process may be implemented for verifying the login credentials, such as looking up a username and password in a user database. If the login credentials are invalid, the login page 300 may be re-presented or the session may be terminated. If the login credentials are validated, access to various features of the multi-modal fare calculation system is granted. It is understood that the multi-modal fare calculation application can be delivered over a network to passengers on a subscription basis, which may be fee-based. Subscriptions may be made available to mass transit providers, hotels, travel agents, tourist bureaus, corporate trip planners and other members of the travel industry.

Also at Step 204, a user may register with the administrator of the multi-modal fare calculation system via a registration feature 304. A user may elect to register with the system if the user is not already established as a “passenger” or other recognized “member” of the community that can access the multi-modal fare calculation system. Registering with the administrator allows the system to uniquely identify each passenger that will be requesting directions for a journey and for whom the system shall calculate fares for the totality of multi-segment journeys that will be generated for and presented to the passenger for consideration. Once a non-member becomes a member, the member can set up a user profile at the login page and access the multi-modal fare calculation system. During registration, the administrator may deny the registration, for example, if all requested data has not been submitted or if the user is already an active member of the network.

Although FIG. 2 shows Step 204 as enabling users to access a “network”, it is understood that if desired, the system can be configured to implement architecture in which users may join a social network or any other symbiotic network that is built, maintained and/or nourished by the administrator to facilitate sharing of fare calculations among passengers. Information can be shared among users regarding the cumulative comparative fares charged for one or more itineraries that are created for a multi-segment, multi-mode journey.

A user can also access a social networking feature 306 to initiate a social networking method for building an online presence in a collaborative social networking system, which may be a site or website. The method of having a social network specifically designed around the relationship among passengers includes unique architecture. Such architecture can promote the flow of information and recommendations among passengers who would benefit from the same information. Passengers can discuss and synthesize the recommendation that they may have received from the system and from other passengers. A user may access a collaborative social networking system via a log-in that may be immediately presented or may be accessible from another web page or from a mobile application. New users can create, and registered users can modify, a preference profile that can include attributes such as age, gender, residential and work neighborhoods, preferred itineraries and favorite destinations, although the collaborative social networking system is not limited to these attributes.

Successful access to the multi-modal fare calculation system at Step 204 may be effected by a user that downloads a multi-modal fare calculation application on a network-connected device. The multi-modal fare calculation system can facilitate user access to the multi-modal fare calculation system, for instance, via a user interface such as a log-in screen as described hereinabove. The multi-modal fare calculation system application may be distributed as a software tool configured for mobile applications that is downloaded to passengers as part of a program for navigation in urban environments (e.g., as shown and described by the '871 patent).

The application can be implemented partly or entirely using a cloud service. Step 204 may include, for example, implementations in which a browser is used to access an application, a cloud application in which a user would login to the cloud application to interact with the application, or combinations of local and remote software.

At Step 206, a user inputs information about a desired journey by entering at least a start address and a destination address via a network interface. An exemplary network interface is shown in FIG. 3, on which a journey input page 300 is presented. Journey input page 300 is an example of a network interface by which a passenger can enter journey information and may have a variety of appearances and applications as understood by a person of ordinary skill in the art. Journey input page 300 may include a starting address entry region 308 and a destination address entry region 310. An option for selecting the direction and/or duration of the journey may be provided, for example by a box 312 having a drop down menu (e.g., for selecting one-way or round-trip journeys or for selecting journeys with multiple destinations). For more localized fare calculations and directions, a passenger may select a borough or area of the metropolitan area in which the journey is conducted. For example, as shown in FIG. 3, borough selection box 314 and region selection boxes 316 and 318 permit focused research of a selected starting address and/or destination address. In the example where the journey is taken in the New York City metropolitan area, borough selection box 314 may permit selection of one of the five boroughs of New York City as well as selection of certain counties in the states of New York New Jersey and Connecticut.

Upon entry of the start and destination addresses at journey input page 300, a passenger may also input preferences including one or more preferred transportation modes and/or mass transit providers (e.g., MTA buses and trains, NY Waterway ferries and buses, PATH trains, NJ Transit trains, rideshare providers, etc.). The passenger may input these preferences in combination with acceptable walking distances between journey segments and tolerances for transfers among mass transit vehicles. Journey input page 300 may also include a link to a collaborative social network as described herein, which social network may include one or more of an externally managed social network (e.g., Facebook, LinkedIn) and a social network managed by the administrator of the multi-modal fare calculation system. One or more links may be provided on journey input page 300 to customize the passenger's request, including but not limited to a city selection link 320 for selecting a metropolitan region in which a multi-modal fare is to be calculated, a directions link 322 for providing precise directions for each segment of a journey having one or more segments, a maps link 324, a schedules link 326, a stations link 328 and a city guide 330. Additional links 32 may also be provided that permit the passenger to elect to receive real-time alerts of changes from mass transit providers along with planned service changes announced in advance of a planned journey. Such inputs may be stored in a database as passenger preferences that can be later accessed by the multi-modal fare calculation system when the passenger access the system At Step 208, the passenger requests the presentation of one or more itineraries based upon the criteria input at journey input page 300. The passenger may initiate such request by accessing a “get direction” feature that calculates network segments and generates a variety of itineraries and also calculates fares for each itinerary that includes multi-modal journey segments to which such fares are applied by mass transit providers. Access to such a feature may be effected by a link, for instance as graphically indicated by “Get Direction” button 334. The calculating and displaying of a multi-modal transportation route may be effected by one or more methods, devices and systems, including but not limited to those disclosed by the '871 patent. Node numbers may be found for the starting and destination addresses by employing any suitable algorithm for route-finding (e.g., Djikstra's algorithm or A* algorithms). A method for determining the shortest path between two nodes in a network may be employed, for example by incorporating the methods disclosed by co-owned and co-pending U.S. Ser. No. 13/722,723 filed Dec. 20, 2012, the entire disclosure of which is incorporated by reference herein. Current information, such as current mass transit conditions and walking conditions, can be factored into the routing decisions.

At Step 210, the multi-modal fare calculation system validates the starting and destination addresses for the requested journey. At Step 212, the coordinates of the validated addresses are found (for example, within one or more nodes). The coordinates may be determined by identifying the location where the passenger has indicated the first segment of the journey will commence and further identifying the location where the passenger has indicated the final segment of the journey will end.

At Step 214, a module in the multi-modal fare calculation system is able to generate one or more itinerary options for transit from the journey's starting location to the journey's destination location. Itineraries may be generated using transit data, for example, as acquired from a feed such as the General Transit Feed Specification (GTFS). At Step 214, the multi-modal fare calculation system calculates multi-modal transportation routes by determining whether a particular route segment corresponds to any segment of the requested journey. Based upon the journey input parameters, the module determines segment parameters including, but not limited to, the starting and ending locations of each segment in a multi-segment journey, the start and end times for any given segment, the identification of mass transit providers and agencies that provide transit modes at any given starting and ending location for any given segment and the identification of modes and conveyance types employed by the mass transit providers at each starting and ending location. Also at Step 214, searching is conducted for a chain of segments in which each of the journey's start and end locations, along with each segments start end locations, are located in particular groups of “stops” or coordinates identifiable as being served with a mass transit provider.

As multiple itineraries are generated for the same requested journey, a cumulative fare calculation module in the multi-modal fare calculation system executes instructions to translate any given itinerary to obtain a total fare calculation for the entire journey at Step 216. A total fare for each itinerary generated for a requested journey is successfully calculated by the multi-modal fare calculation system regardless of the number of segments and transit modes within the generated itinerary. Thus, for a set of mass transit providers (with each provider being regulated and/or having fares set by one or more private or government agencies), a total fare for a complete journey is calculated across transit providers and agencies whether or not fare data is readily available (thereby incorporating fare data that is often not provided in tables).

At Step 216, the multi-modal fare calculation system calculates and sets a cumulative fare for all of the segments in each itinerary generated for the journey by following applicable fare rules (e.g., all trips within a segment have the same fare with unlimited transfers; fares are dependent on geographic zones; fares are dependent upon the proximity of one segment's segment_end_stop_id to the following segment's segment_start_stop_id; etc.). A rule has a name, a position (e.g., the order in which the rule will be applied) and associated code that is used to calculate the fare. In this manner, how far a passenger travels within a journey will be the culmination of many database tables that hold certain information, including fare information for a given journey segment in a given itinerary and on a particular mode of transit.

FIG. 2A shows an exemplary cumulative fare calculation process that is executed at Step 216. At Step 216a, an online service (e.g., a website, mobile application, etc.) is implemented that receives local transit start and destination information and identifies one or public transit routes for complete travel between locations using one or more local travel transit agencies that service different geographic areas. At Step 216b, fare-related data is received and stored from the local travel transit agencies and other sources (e.g., via one or more data feeds, input data, aggregated data, standardized data, etc.). An optional price feed may be implemented at Step 216c by which a price is requested for a particular journey or trip and a corresponding price is received in response.

At Step 216d, a module is implemented that processes data when an itinerary is identified for a particular journey or trip having one or more segments. The module is adapted to use the data to determine a fare price for one or more segments (or legs) of a particular itinerary and to provide a total fare for the journey. The module uses the characteristics of the journey and/or a segment of the journey to determine how much the local mass transit provider will charge for the expected journey or trip. For example, the process can use a combination of a price feed from one segment and calculate a price for another segment using rules that are applied to the segment parameters and/or characteristics (e.g., the number of required or tolerated transfers, weekday/weekend travel, the required or preferred transit modes, etc.). Sample inputs to the multi-modal fare calculation system that can be processed by the module to determine a cumulative fare may include the following:
Each journey is served by one or more transit modes provided by one or more local mass transit providers. The journey has the following input parameters:
   Start_stop_id: the stop where the passenger embarks on the first transit mode employed on the journey
   End_stop_id: the stop where the user disembarks the last transit mode employed on the journey
   Route_id: identification of the geographic extent of the journey
   Start_date and time of journey
   End_date and time of journey
Based upon the journey input parameters, a module may determine the following segment parameters:
   Vehicle type: the transit mode available for each segment (e.g., “S” (subway), “B” (bus), “F” (ferry), “R” (regional rail), etc.)
   Segment_start_stop_id: the stop or location where the passenger embarks on a given segment
   Segment_end_stop_id: the stop or location where the passenger disembarks from a transit mode employed on a given segment
   Vehicle_id: identification of vehicle providing transit service for a given segment
   Start_date and time of a given segment
   End date and time for a given segment
   Agency id: identification of mass transit providers providing an available transit mode for a given segment

At Step 216d, a decision 216e may be implemented during which the parameters of the segment (e.g., the starting or ending location of each segment, the distance covered by each segment, the duration of each segment inconsideration of date and/or time of travel, etc.) will determine how established rules are applied to each segment and to the journey as a whole. As an example, Rule 1 establishes that “vehicle_type==B” & and “agency_id==12345”. When Rule 1 is applied to the segment, and the vehicle of the segment is of type ‘B’, and the ID of the transit agency is 12345, Rule 1 assigns the applicable fare to the segment (see Step 216f). The segment gets treated as resolved, and the process advances to the next segment.

Additional segment fares are determined according to the next assigned rule to determine the applicable fare. The next assigned rule may be any of the next rule, the first rule or a continuation of the current rule. When the process of assigning a fare commences, the first segment becomes current and Rule 1 is applied thereto. If the first segment do not satisfy Rule 1, then Rule 2 is applied. If the first segment satisfies the conditions of Rule 2, then Rule 2 assigns the applicable fare to the first segment. The current segment instantly switches to the next segment, and, at this point, the code that executes Rule 2 keeps being executed after assigning the fare to the first segment. The code that executes Rule 2 can send the execution process to Rule 3, or to Rule 1, or it can continue to execute Rule 2. The rule itself, therefore, determines where the process will go after assigning a fare to a journey segment. If the process reaches the last rule, a decision process 216g may be implemented to determine whether the segment satisfies the rule. If the last rule has been reached and the segment does not satisfy the rule, then the segment gets treated as not resolved and the entire process stops (whereupon process 200 resumes). This is because it is unnecessary to calculate fares for additional journey segments if one of the segments does not have an assigned fare.

Custom coding logic employed by the multi-modal fare calculation system can therefore, in addition to receiving publicly available fare data, take into consideration feedback from users regarding fare updates and potential fare calculations to ensure the accuracy of fare calculations for an entire journey served by multiple transit providers, regardless of how many segments are in a particular itinerary. The code may be written in a custom language and/or syntax (e.g., one that may be close to the syntax of C++).

In dynamically evaluating fares over multiple itineraries for a journey involving multiple modes of transit and served by multiple local mass transit providers, the multi-modal fare calculation system incorporates (1) a component for determining a pre-specified fare price for each segment serviced by a mass transit provider, and (2) a component that employs a rule-dependent algorithm for calculating fares dependent upon the fare rules being applied to the specified journey (e.g., rules applying to the time and day of the journey, rules for transfer among modes of transit and among mass transit providers, any special status applied to the passenger such as senior citizen status or mobility impaired status, etc.). The rule-dependent algorithm finds the rule(s) applicable to the journey input by the passenger at journey input page 300 and applies the rules among multiple itineraries that are generated to get from the starting address to the destination address. In so calculating the fares in concert with the various routes, the multi-modal fare calculation system calculates a total fare for the entire input journey across multiple mass transit providers and agencies.

At Step 218, the various itineraries are displayed on a network interface along with the cumulative fares calculated by the multi-modal fare calculation system. An exemplary display is shown in FIG. 4 on a display page 400 that may incorporate registration, log-in and social networking features as described hereinabove. An exemplary itinerary 402 shows a recommended route for an exemplary multi-segment journey that incorporates two walking segments 402a, two segments 402b operating a mode that is serviced by a first mass transit provider and one segment 402c operating a mode that is serviced by a second mass transit provider. Display page 400 can include a variety of data corresponding to itinerary 402, including but not limited to the number of transfers required during the journey, the total walking time, the total trip time and the departure and arrival time. Itinerary 402 shows that the cumulative fare for the recommended route is $15.50, which amount can be compared with an alternative itinerary 404 (incorporating modes from one or more different mass transit providers and having a cumulative fare of $15.50 with three walking segments).

In some embodiments, the multi-modal fare calculation system facilities fare purchase and/or ticketing for one or more itineraries selected from the multi-segment journeys generated by the multi-modal fare calculation system. The fare purchase and/or ticket may be enabled across mass transit providers at the time a passenger selects a journey, in addition to calculating the total fare for a multi-segment journey served by the local mass transit providers. Confirmation of fare payment may be delivered to a mobile device and confirmation of fare payment communicated at a transit stop (e.g., as by near-field communication or by presentation of a confirmation code that may be provided as a bar code, QR code or any comparable or equivalent confirmation code).

Such embodiments may be complemented by or combined with embodiments of the multi-modal fare calculation system that enable a passenger to also calculate fares across transit modes of one mass transit provider. One mass transit provider may serve more than one segment of a multi-segment journey (e.g., the same mass transit provider provides bus service along one segment and train service along another segment of an itinerary for a multi-segment journey) while one or more different mass transit providers serve additional segments of the same multi-segment journey (e.g, a different mass transit provider provides ferry or van shuttle service along another segment of the same or different itinerary for the multi-segment journey).

The processes, steps, or methods illustratively described herein can be implemented using the described examples of hardware and network configurations.

It is understood that activity described from a user's perspective also encompasses the related features that are implemented on the system, platform, software, or process as part of providing that activity, operation, or interaction. Terms such as “adapted”, “configured” or “implemented” indicate that software, hardware (including computer-readable) and/or combinations thereof are implemented by way of computer programs or circuitry to implement a particular structure or specialized computer system. If the terms are not specifically used, one of ordinary skill in the art will understand that it was contemplated in general or based on the specific context.

It is understood that the presently disclosed invention is not to be limited to the exact configurations as illustrated and described herein. To those of ordinary skill in the art, one or more inventions will be understood to be contemplated from the present application. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A computer-implemented method for dynamically evaluating fares over multiple itineraries for a journey involving multiple modes of transit and served by multiple mass transit providers, the method comprising:
inputting a starting address and a destination address of a journey during which a passenger accesses at least one mass transit provider from a plurality of mass transit providers during one or more journey segments;
identifying a start point and an end point for each journey segment;
determining mass transit directions that afford access to at least one mass transit provider during each journey segment with each segment being served by a mass transit provider;
calculating cumulative fares for the mass transit providers providing transit services during the journey; and
for each itinerary, displaying the cumulative fares with at least one of textual descriptions and graphical descriptions of the mass transit directions.

2. The method of claim 1, further including providing a platform comprising:
a network interface for performing at least one of:
communicating over a network;
inputting the starting and destination addresses for a requested multi-segment journey;
inputting journey customization data;
facilitating registration of at least one passenger requesting the mass transit directions; and
accessing the platform by the registered passenger;
a database that stores cumulative fare data, with the cumulative fare data including pre-specified fare data for each segment served by a mass transit provider and acquired from at least one data feed, and also including rule-dependent fare data for calculating fares dependent upon the fare rules being applied to one or more segments of the requested journey; and
an engine configured to perform at least one of:
validating the starting and destination addresses for the requested multi-segment journey;
determining the mass transit directions between two nodes in a network comprising a plurality of nodes;
associating the third-party fare data with a given segment; and
calculating and setting a cumulative fare for each itinerary generated for the requested multi-segment journey.

3. The method of claim 2, wherein the network interface includes a journey input page for inputting at least one of the start point of the journey, the end point of the journey, one or more preferred transportation modes, one or more preferred mass transit providers and preferred walking distances between a location of an end point of one journey segment and a location of a start point of another journey segment.

4. The method of claim 2, wherein the platform further comprises a network interface for allowing a passenger to provide feedback on at least one of accuracy of the cumulative fare data and quality of the mass transit directions.

5. The method of claim 4, wherein the network interface provides access to a collaborative social network.

6. The method of claim 2, wherein the journey customization data includes at least one transit region selected from a plurality of transit regions in which the cumulative fare data is calculated, directions for each segment of the requested multi-segment journey, one or more maps, one or more transit schedules and one or more guides for a selected transit region.

7. The method of claim 2, wherein the validating includes identifying a location where the passenger has indicated a first segment of the requested multi-segment journey will commence, identifying a location where the passenger has indicated a final segment of the multi-segment journey will end and searching for a chain of segments in which each of the journey's start and end locations, along with each segment's start and end locations, are located in identified groups of coordinates identifiable as being served by a mass transit provider.

8. The method of claim 2, wherein the network interface performs at least one of:
facilitating purchase of a fare for at least one of the requested multi-segment journey and any given segment thereof; and
presenting confirmation of fare payment on a network-connected device.

9. A multi-modal fare calculation system for evaluating fares over multiple itineraries for a journey involving multiple modes of transit and served by multiple mass transit providers, the system comprising:
a journey input module that receives a starting address and a destination address of a journey during which a passenger accesses at least one mass transit provider from a plurality of mass transit providers during one or more journey segments;
an identifying module for identifying a start point and an end point for each journey segment;
a determining module for determining mass transit directions that afford access to at least one mass transit provider during each journey segment with each segment being served by a mass transit provider;
a calculating module that calculates cumulative fares for the mass transit providers providing transit services during the journey;
a display module that, for each itinerary, displays the cumulative fares with at least one of textual descriptions and graphical descriptions of the mass transit directions; and
a server configured to perform actions comprising:
accessing the system over the network; and
performing the method of claim 1.

10. The system of claim 9, further comprising:
a platform comprising:
a network interface for performing at least one of:
communicating over a network;
inputting the starting and destination addresses for a requested multi-segment journey;
inputting journey customization data;
facilitating registration of at least one passenger requesting the mass transit directions; and
accessing the platform by the registered passenger;
a database that stores cumulative fare data, with the cumulative fare data including pre-specified fare data for each segment served by a mass transit provider and acquired from at least one data feed, and also including rule-dependent fare data for calculating fares dependent upon the fare rules being applied to one or more segments of the requested multi-segment journey; and
an engine configured to perform at least one of:
validating the starting and destination addresses for the requested multi-segment journey;
determining the mass transit directions between two nodes in a network comprising a plurality of nodes;
associating the third-party fare data with a given segment; and
calculating and setting a cumulative fare for each itinerary generated for the requested multi-segment journey.

11. The system of claim 10, wherein the network interface includes a journey input page for inputting at least one of the start point of the journey, the end point of the journey, one or more preferred transportation modes, one or more preferred mass transit providers and preferred walking distances between a location of an end point of one journey segment and a location of a start point of another journey segment.

12. The system of claim 10, wherein the platform further comprises a network interface for allowing a passenger to provide feedback on at least one of accuracy of the cumulative fare data and quality of the mass transit directions.

13. The system of claim 12, wherein the network interface provides access to a collaborative social network.

14. The system of claim 10, where in the journey customization data includes at least one transit region selected from a plurality of transit regions in which the cumulative fare data is calculated, directions for each segment of the requested multi-segment journey, one or more maps, one or more transit schedules and one or more guides for a selected transit region.

15. The system of claim 10, further comprising a validating module for identifying a location where the passenger has indicated a first segment of the multi-segment journey will commence, identifying a location where the passenger has indicated a final segment of the multi-segment journey will end and searching for a chain of segments in which each of the journey's start and end locations, along with each segment's start and end locations, are located in identified groups of coordinates identifiable as being served by a mass transit provider.

16. The system of claim 10, further comprising a purchase module for facilitating purchase of a fare for at least one of the requested multi-segment journey and any given segment thereof.

17. The system of claim 16, further comprising a confirmation module for delivering confirmation of fare payment to a network-connected device.

18. A non-transitory computer-readable medium comprising a plurality of instructions that, when executed by at least one network-connectable device, at least cause the device to evaluate fares over multiple itineraries for a journey involving multiple modes of transit and served by multiple mass transit providers, wherein evaluating the fare includes:
inputting a starting address and a destination address of a journey during which a passenger accesses at least one mass transit provider from a plurality of mass transit providers during one or more journey segments;
identifying a start point and an end point for each journey segment;
determining mass transit directions that afford access to at least one mass transit provider during each journey segment with each segment being served by a mass transit provider;
calculating cumulative fares for the mass transit providers providing transit services during the journey; and
for each itinerary, displaying the cumulative fares with at least one of textual descriptions and graphical descriptions of the mass transit directions.

19. An apparatus for evaluating fares over multiple itineraries for a journey involving multiple modes of transit and served by multiple mass transit providers, comprising:
a network interface for communicating over a network; and
a computer-readable medium configured to perform actions that comprise:
inputting a starting address and a destination address of a journey during which a passenger accesses at least one mass transit provider from a plurality of mass transit providers during one or more journey segments;
identifying a start point and an end point for each journey segment;
determining mass transit directions that afford access to at least one mass transit provider during each journey segment with each segment being served by a mass transit provider,
calculating cumulative fares for the mass transit providers providing transit services during the journey; and
for each itinerary, displaying the cumulative fares with at least one of textual descriptions and graphical descriptions of the mass transit directions.

20. A method of operation of an apparatus for inputting a starting address and a destination address of a journey during which a passenger accesses at least one mass transit provider from a plurality of mass transit providers during one or more journey segments, the method comprising using the apparatus to:
communicate over a network; and
perform actions that comprise:
identifying a start point and an end point for each journey segment;
determining mass transit directions that afford access to at least one mass transit provider during each journey segment with each segment being served by a mass transit provider,
calculating cumulative fares for the mass transit providers providing transit services during the journey; and
for each itinerary, displaying the cumulative fares with at least one of textual descriptions and graphical descriptions of the mass transit directions.
